(19) United States
(12) Patent Application Publication
(10) Pub. No.: US 2006/0038675 A1
(43) Pub. Date: Feb. 23, 2006

(54) Sur-link system

(76) Inventor: William Hodges, Philadelphia, PA (US)

Correspondence Address: William Hodges, 2621 Deacon Street, Philadelphia, PA, 19129, US

(21) Appl. No.: 10/829,384

(22) Filed: Aug. 23, 2004

(51) Int. Cl. G08B 1/08; G08B 23/00

(52) U.S. Cl. 340/539.23; 340/539.32; 340/573.4

(57) ABSTRACT

The Sur-Link system will link a person to any portable apparatus they may randomly misplace or enable one to monitor such things as a pocket book, cell phone or any other object that they could leave behind. This unit may be used for keys or attached to a child that you desire to keep within a safe distance and many other uses by means of an electronic sending unit that you attached to a child or object you want to protect from loss or separation. The receiving unit is attached to the person that is similar to a beeper or warning device which will sound an alarm when a distance of a few feet separates the receiver unit from the sending device attached to the unit you seek to monitor.

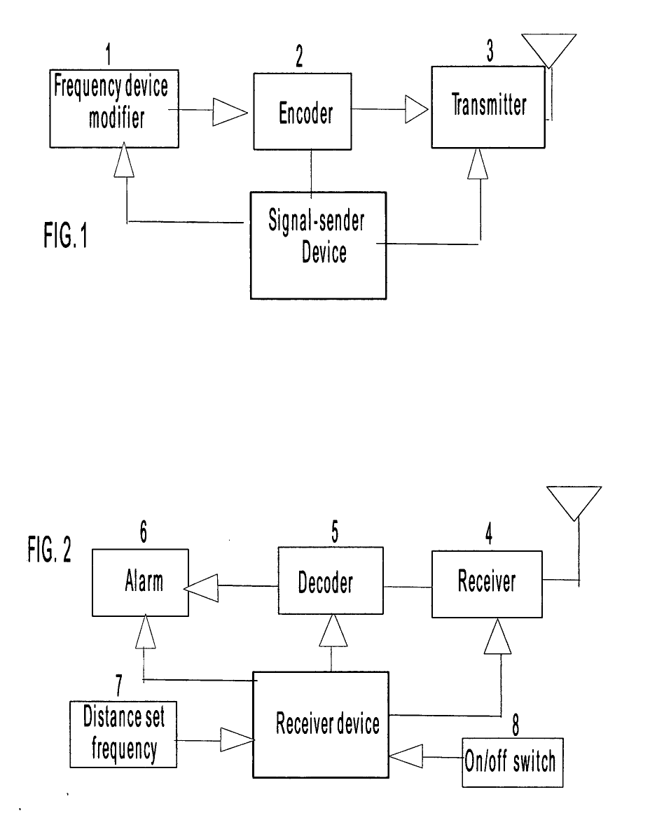

This system will allow a person to be aware of any object that one may randomly misplace such as, pocket book, cell phone or any other object on ones person.

This unit will activate a signal when sender unit is more than (2) two feet from the receiver alarm unit. The signal sender will activate the receiver by way of a bio-directional switch within the sender unit.

There is a constant radio signal between units which is adjustible, but when the signal is broken it will cause the receiver alarm to sound and or vibration.

This unit may be used for keys, and can be attached to a child that you desire to keep within a safe distance, and many other uses All components in this unit is consistant with standard signal sendig and receivng devices.

The receiver unit can be worn as a beeper type unit, and signal sender must be located on the object you seek to monitor. This unit is designed to reduce losses of personal objects.

[image]

1. The cell phone (1) is the receiving device of a continuous low frequency signal being sent from a small signal out put apparatus. When the signal from the signal apparatus (2) is broken by the distance of three or more feet from the cell phone, it will cause the phone to respond by ringing or create other sounds that will alert you that you are moving away from the phone. In this case the sending unit will be placed in your wallet or pocket and will remain with you. This combination unit can be used in other ways by placing the sending unit on any product or child that you, may lose sight on or tend to forget. As the cell phone responds to the Surlink System it will show on the LED otherwise the phone will function normally when receiving calls.
(1). Person may be able to avoid the loss of their cell phone and the inconvenience of waiting for or buying a new phone.
(2) This system will eliminate lots of insurance claims for lost cell phones.
(3) This system will allow a comprehensive use of the telephone and a constant connection to items you may lose or tend to forget such as brief cases, bags, and pocket books, etc.
(4) This unit can protect against the loss of a child in the event you get preoccupied while shopping, or at a playground or any location by attaching the sending unit to the child, and taking proper care of the unit itself.
